(19) United States
(12) Patent Application Publication
(10) Pub. No.: US 2024/0141872 A1
(43) Pub. Date: May 2, 2024

(54) Method, Repair Device and Repair System for Repairing a Corrosion Damage of a Surface of an Object Exposed to Weather

(71) Applicant: Glatt Gesellschaft mit beschränkter Haftung, Binzen (DE)

(72) Inventors: Reinhard Nowak, Lörrach (DE); Michael Grimann, Kassel (DE); Eckhardt Krebs, Witterda (DE)

(21) Appl. No.: 18/281,086

(22) PCT Filed: Mar. 4, 2022
(86) PCT No.: PCT/EP2022/055603

§ 371 Date: Sep. 8, 2023

(30) Foreign Application Priority Data
Mar. 11, 2021 (DE) 10 2021 202 380.0

(51) Int. Cl. F03D 80/50; B08B 7/00; B23P 6/00; F03D 80/55

(52) U.S. Cl. CPC F03D 80/507; B08B 7/0042; B23P 6/00; F03D 80/55; F05D 2230/80; F05D 2230/90

(57) ABSTRACT

A method, a repair device and a repair system for repairing a corrosion damage of a surface of an object exposed to weather. The method includes laserless pre-cleaning of the surface with the corrosion damage, laser cleaning of the surface with the corrosion damage and coating of the surface treated by laser cleaning with a protective layer.

### CROSS-REFERENCE TO RELATED APPLICATIONS

This application is the United States national phase of International Application No. PCT/EP2022/055603 filed Mar. 4, 2022, and claims priority to German Patent Application No. 10 2021 202 380.0 filed Mar. 11, 2021, the disclosures of which are hereby incorporated by reference in their entireties.

### BACKGROUND

### Field

The invention relates to a method, a repair device and a repair system for repairing corrosion damage of a surface of an object exposed to weather.

### Description of Related Art

With all types of objects, in particular with wind turbines, corrosion-related damage frequently occurs on surfaces of the object exposed to weather. The corrosion-related damage can lead to the object in question being impaired in its use.

### SUMMARY

The object of the invention is to repair the corrosion damage on the objects.

This object is achieved with a method of the type mentioned in the introduction by virtue of the fact that the method steps a) laserless pre-cleaning of the surface with the corrosion damage, b) laser cleaning of the surface with the corrosion damage and c) coating of the surface treated by laser cleaning with a protective layer are carried out by means of a repair device. Surprisingly, it was discovered that through the method, the coating applied as a protective layer to the surface of the object treated by laser cleaning is of higher quality and thus more durable.

Corrosion damage should be understood to mean, on the one hand, that corrosion forms on the surface of the object exposed to weather, in particular the wind turbine, and, on the other hand, that, for example, a faulty coating has been applied to the surface. Repairing the corrosion damage now consists of removing the corroded material and/or the defectively applied coating.

According to a related further development of the method, precleaning of the surface with the corrosion damage comprises preliminary cleaning and/or desalination and/or drying of the surface.

Preliminary cleaning is expediently carried out with a chemical cleaning agent, such as water-soluble surfactants, or by means of mechanical cleaning, for example by means of a brush unit. Preliminary cleaning is used, for example, to clean oil-containing contaminants, contaminants resulting from wear parts, salt contaminants and other contaminants caused by dirt from the surface with the corrosion damage.

The desalination is preferably carried out with deionized water. Deionized water is also referred to as demineralized or distilled water. According to a further embodiment of the method, after desalination, a concentration measurement of the soluble salts is carried out on the surface with the corrosion damage.

The concentration measurement of the soluble salts is carried out by means of the Bresle method. When protecting surfaces exposed to weather, the surface must be checked for salt contamination prior to coating. Salt contamination may have a considerable impact on the adhesion and quality of the coating. The Bresle method based on increasing the electrical conductivity of water as a function of the concentration of salt ions is standard for this test according to ISO standards 8502-6 and 8502-9.

The surface is preferably dried with unoiled compressed air. This removes the residues of the preliminary cleaning and/or desalination from the surface with the corrosion damage.

According to an additional advantageous embodiment of the method, after pre-cleaning of the surface with the corrosion damage, this surface is at least partially subjected to a material-removing surface post-treatment. During this surface posttreatment, edges formed by the surface are expediently removed. This preparatory measure also ensures improved adhesion of the applied protective layer on the surface and thus provides a higher quality and more long-lasting coating.

According to a further advantageous embodiment, the laser cleaning of the surface with the corrosion damage comprises removing the corroded material by a laser beam and extraction of the removed corroded material. Laser cleaning is carried out with specially configured class 4 solid-state lasers, wherein short laser pulses strike the surface to be cleaned in a concentrated manner. The layer of corroded material is removed from the surface to be cleaned by the at least partially absorbed laser radiation. The laser cleaning enables selective, gentle, deep and damage-free cleaning of the surface with the corrosion damage.

The simultaneous extraction of the removed corroded material ensures substantially residue-free cleaning of the surface with the corrosion damage.

After the laser cleaning, an inspection of the surface roughness of the surface treated with a laser beam is preferably carried out. In order to inspect the surface roughness, an impression of at least part of the laser-cleaned surface is produced and the surface roughness of the impression is analysed. Only the part of the laser-cleaned surface used for the impression is cleaned again after producing the impression. The re-cleaning is carried out with an alcohol, expediently with propan-2-ol. The surface roughness test enables the—usually downstream—assessment of the surface prepared for coating and thus an assessment of the quality and durability of the applied protective layer.

Moreover, in one preferred embodiment of the method, the protective layer is applied to the surface treated by the laser cleaning in one or more layers. By way of example, a multi-layered protective layer enables further improvement of the quality and durability of the applied coating. Various layers with different layer thicknesses can also be produced here in order to adapt the coating to the requirements of the weather.

The method is expediently carried out as an in-situ method.

The method is preferably used to repair corrosion damage of a surface of an object formed by a wind turbine, in particular an offshore wind turbine, exposed to weather. The repair device for carrying out the method is releasably attached to the wind turbine, in particular to a brake caliper of a rotor braking device of the wind turbine, in particular by means of permanent magnetic forces. Offshore wind turbines often experience corrosion damage due to the seawater weather conditions, meaning that the method can be optimally used here in particular for repairing corrosion damage of a surface of a wind turbine, in particular an offshore wind turbine, exposed to weather.

Moreover, this object is achieved with a repair device of the type mentioned in the introduction by virtue of the fact that the repair device has a support device having an alignment device suitable for receiving an end effector, wherein the alignment device is suitable for displacing and/or pivoting the end effector arranged on the alignment device, wherein the support device has a holding device, by means of which the support device can be attached to the object in such a way that the alignment device receiving the end effector is positioned in the area of the corrosion damage. It is possible to repair the resulting corrosion damage in-situ on the object thanks to the repair device.

Corrosion damage should be understood to mean, on the one hand, that corrosion forms on the surface of the object exposed to weather, in particular the wind turbine, and, on the other hand, that, for example, a faulty coating has been applied to the surface. Repairing the corrosion damage now consists of removing the corroded material and/or the defectively applied coating.

In a related advantageous embodiment of the repair device, the end effector is releasably arranged on the alignment device to enable an exchange with another end effector. The exchange of the end effector results in a multi-functionality of the repair device, which also subsequently leads to an expansion of the functions of the repair device.

The holding device preferably has a fastening device for releasably attaching the support device to the object. The fastening device is designed as a permanent magnetic device for magnetically attaching the support device to the object. This provides a very simple attachment option.

Furthermore, the holding device has a base body, on which the fastening device and a support arm supporting the alignment device are arranged. The support arm is arranged on the base body of the holding device such that it can be pivoted and fixed in different pivoting positions.

The alignment device expediently has an end effector support moveably arranged on the support arm and positioning means, by means of which the end effector support can be moved and aligned relative to the support arm.

According to a further advantageous embodiment of the repair device, the end effector is designed as a laser device and/or as a pre-cleaning device and/or as a coating device and/or as a drying device and/or as an impression-taking device and/or as a layer thickness measurement device.

The laser device preferably has a laser head and a laser source, wherein the laser source is connected to the laser head by means of a light transmitter. This enables a decentralized arrangement of the laser device. The laser device further preferably has an extraction device for extracting corroded material that occurs during the removal of the corrosion. The laser cleaning enables selective, gentle, deep and damage-free cleaning of the surface with the corrosion damage. The preferably simultaneous extraction of the removed corroded material ensures substantially residue-free cleaning of the surface with the corrosion damage.

According to one advantageous embodiment of the repair device, the pre-cleaning device has a preliminary cleaning unit and/or a desalination unit and/or a drying unit and/or a concentration measurement unit.

Preliminary cleaning is expediently carried out with a chemical cleaning agent, such as water-soluble surfactants, which can be applied by the preliminary cleaning unit to the corresponding surface, in particular by spraying by means of a spray nozzle, preferably a single-component nozzle or a multicomponent nozzle. The cleaning agent can also be sprayed on under pressure. Preliminary cleaning can also be carried out by means of mechanical cleaning, for example by means of a brush unit arranged on the end effector, which preferably has one or more brush heads. Preliminary cleaning is used, for example, to clean oil-containing contaminants, contaminants resulting from wear parts, salt contaminants and other contaminants caused by dirt from the surface with the corrosion damage.

The desalination is preferably carried out with deionized water. The deionized water is also preferably sprayed onto the corresponding surface to be desalinated by means of a spraying device formed as a spray nozzle device, in particular as a single-component nozzle or multicomponent nozzle.

The concentration measurement of the soluble salts carried out after desalination on the surface with the corrosion damage is carried out by means of the Bresle method.

The surface is preferably dried with a compressed air device atomizing unoiled compressed air. This removes the residues of the preliminary cleaning and/or desalination from the surface with the corrosion damage.

The protective layer is expediently applied to the surface of the object, in particular the wind turbine, which has been treated by pre-cleaning and laser cleaning, by means of the coating device. The coating device is preferably designed as a spray nozzle device in the form of a single-component nozzle or multicomponent nozzle. This enables the protective layer to be applied to the treated surface with a constant, predefined layer thickness such that the protective layer dries evenly.

The layer thickness measurement device is suitable for determining the layer thickness of the protective layer applied to the treated surface in a non-destructive method. Non-destructive methods include, inter alia, eddy current testing, microwave testing, ultrasound testing.

The repair device expediently has a control device for controlling and/or regulating the repair device. The end effector(s) of the repair device is/are preferably controlled and/or regulated by the control device in order to substantially automate the method for repairing corrosion damage of a surface of an object exposed to weather.

Moreover, this object is achieved with a repair system of the type mentioned in the introduction by virtue of the fact that it is a repair system having a repair device as described herein and a wind turbine, wherein the repair device is releasably attacked to the wind turbine.

In the case of a repair system of this kind, the repair device is preferably attached to a brake caliper of a rotor braking device of the wind turbine, in particular by means of permanent magnetic forces.

The repair device is expediently suitable for carrying out the method as described herein.

### BRIEF DESCRIPTION OF THE DRAWINGS

The terms Fig., Figs., Figure, and Figures are used interchangeably in the specification to refer to the corresponding figures in the drawings.

The invention is explained in more detail below based on the appended drawing, in which

FIG. 1 shows a front view of an embodiment of a repair device,

FIG. 2 shows a side view from the right of the embodiment of the repair device,

FIG. 3 shows a side view from the left of the embodiment of the repair device,

FIG. 4 shows a plan view of the embodiment of the repair device,

FIG. 5 shows a bottom view of the embodiment of the repair device,

FIG. 6 shows a schematic illustration of a first embodiment of an end effector for pre-cleaning and

FIG. 7 shows a schematic illustration of a second embodiment of an end effector with a coating and layer thickness measurement device.

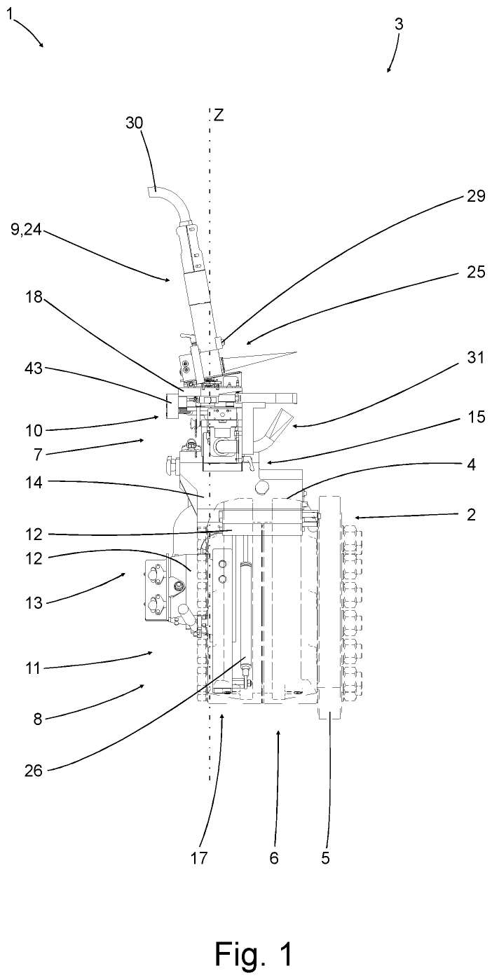

### DETAILED DESCRIPTION

Unless otherwise stated, the following description relates to all embodiments illustrated in the drawing of a repair system 3 having a repair device 1 for repairing corrosion damage of a surface of an object 2 designed as a wind turbine exposed to weather.

Corrosion damage should be understood to mean, on the one hand, corrosion forming on the surface of the object exposed to weather, in particular the wind turbine, and, on the other hand, a coating defectively applied to the surface. Repairing the corrosion damage accordingly consists of removing the corroded material and/or the defectively applied coating.

The repair device 1 is releasably attached to a brake caliper 4 (shown in dashed lines) of a rotor braking device 6, having the brake caliper 4 and a brake disc 5, of the wind turbine, in particular of an offshore wind turbine.

The repair device 1 attached to the brake caliper 4 has a support device 7, which has a holding device 8 and an alignment device 10 suitable for receiving an end effector 9.

The holding device 8 has a fastening device 11 for releasably attaching the support device 7 to the brake caliper 4 of the rotor braking device 6 of the wind turbine.

The fastening device 11 is designed as a permanent magnetic device 13 having two permanent magnets 12 for magnetically attaching the support device 7 to the brake caliper 4.

The holding device 8 has a base body 14 arranged on a permanent magnet 12, on which base body the fastening device 11 and a support arm 15 supporting the alignment device 10 are arranged. The support arm 15 having a longitudinal axis X is arranged on the base body 14 of the holding device 8 such that it can be pivoted and fixed in different pivoting positions 16. By way of example, in the embodiment shown, the support arm 15 is pivoted into a horizontal pivoting position 16 by means of the pivoting device 17 arranged on a permanent magnet 12. The pivoting device 17 is controlled and/or regulated by the control device 32 such that it can pivot the support arm 15 arranged on the base body 14 by means of pneumatically operated pistons 26.

The support device 7 is attached to the object 2 in such a way that the alignment device 10 receiving the end effector 9 is positioned in the area of the corrosion damage.

The alignment device 10 is suitable for displacing and/or pivoting the end effector 9 arranged on the alignment device 10. For this purpose, the alignment device 10 has an end effector support 18 moveably arranged on the support arm 15 and positioning means 18, by means of which the end effector support 18 can be moved and aligned relative to the support arm 15. The positioning means 19 have in particular drive units 20 formed as servomotors, drive spindles 21 and coupling elements 22. For better differentiation, the references for the drive units 20, drive spindles 21 and coupling elements 22 associated with the positioning means 19 are respectively marked a to c.

In order to move the end effector support 18 in the axial direction of the longitudinal axis X of the support arm 15, the end effector support 18 is arranged on a carriage 23 connected to a first drive unit 20a via a first drive spindle 21a and first coupling elements 22a.

In order to align the end effector support 18 about an axis of rotation Y corresponding to the longitudinal axis X of the support arm 15 and about a further axis of rotation Z aligned normal thereto, the end effector support 18 is connected to second and third drive units 20b, 20c of the positioning means 19 via second and third drive spindles 21b, 21c and second and third coupling elements 22b, 22c. For this purpose, the end effector support 18 is arranged on a further carriage 27 such that the end effector support 18 performs a rotation about the axis of rotation Z due to the guiding of the further carriage 27 in an arcuate slot 28 during a movement of the further carriage 27 in the axial direction of the longitudinal axis X. The rotation of the end effector support 18 about the axis of rotation Y is achieved via a gear connection 43 connected to the coupling element 22c.

The positioning means 19 accordingly make it possible to move the end effector support 18 belonging to the alignment device 10 in a spatial coordinate and to be able to rotate it about two axes of rotation independently thereof so as to be able to optimally align the end effector with the surface of an object 2 exposed to weather in order to repair corrosion damage to the surface.

The end effector 9 is releasably arranged on the alignment device 10 to enable an exchange with another end effector 24.

In the illustrated embodiment, the end effector 9 has a laser device 25.

The laser device 25 has a laser head 29 and a laser source, wherein the laser source is connected to the laser head 29 by means of a light transmitter 30.

The laser head 29 is expediently mounted in a remote-controlled laser head holder having multiple degrees of freedom for manipulation. In this way, the laser device 25 is able to achieve various geometric settings that enable laser cleaning of the entire surface area. For all positions, a focus distance of 191 mm to 211 mm can be achieved in the angular range of −3° to +5° to the surface normal. In addition, the laser device 25 has an extraction device 31 for extracting corroded material that occurs during the removal of the corrosion. Since laser cleaning usually produces material emissions, the extraction tube is moved close to the surface to be cleaned.

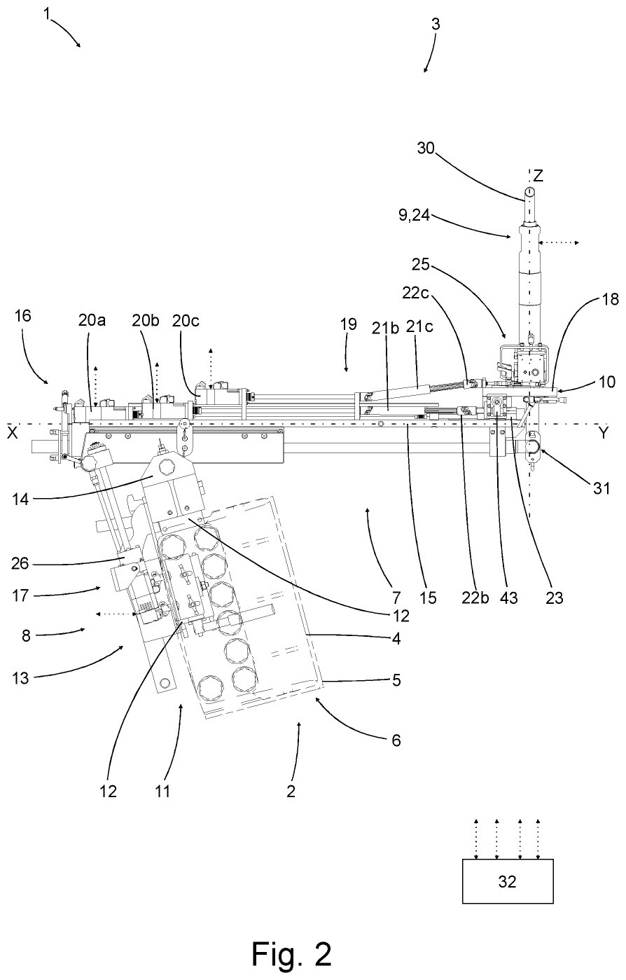

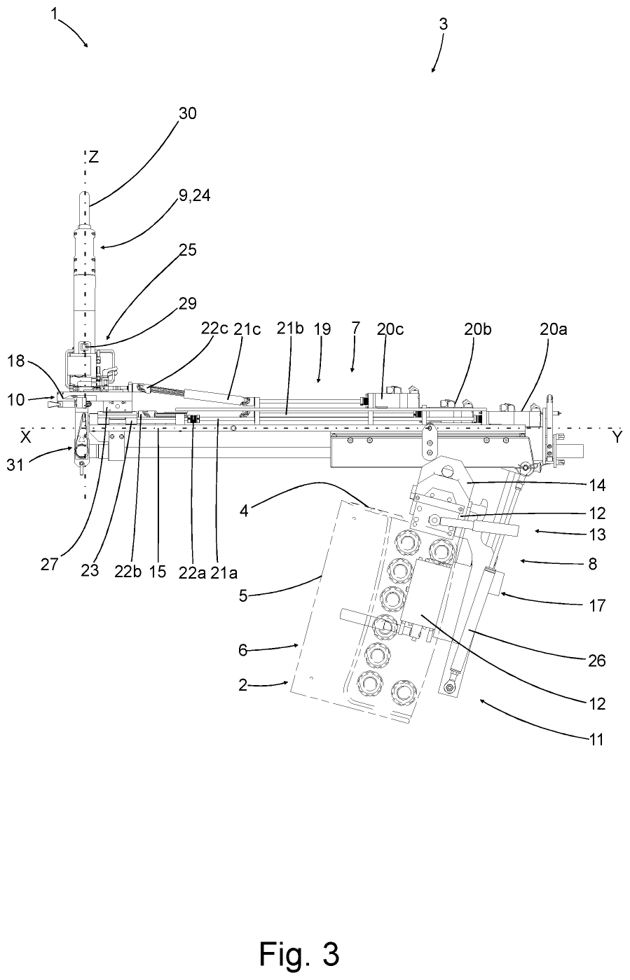

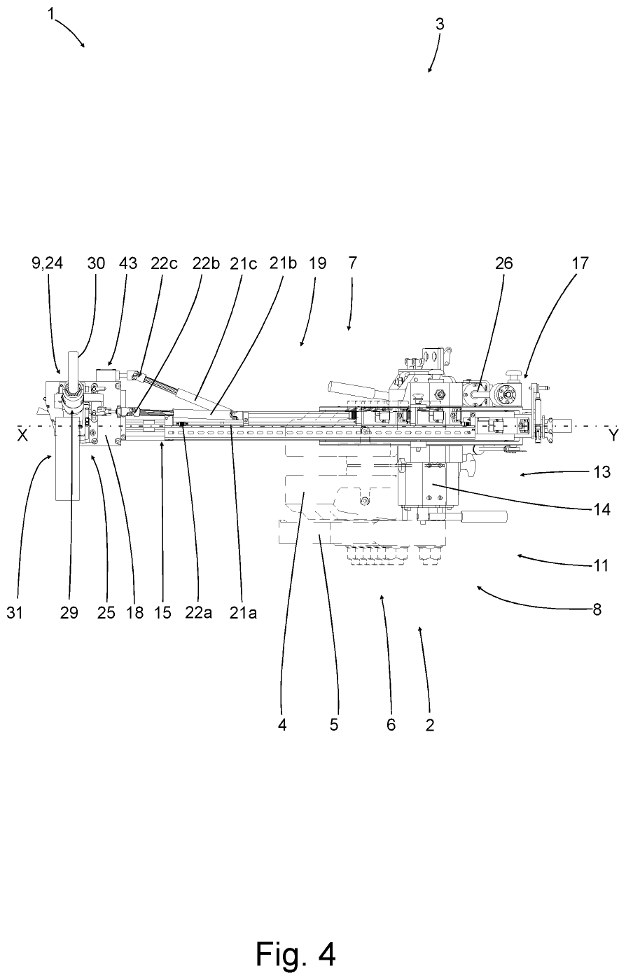

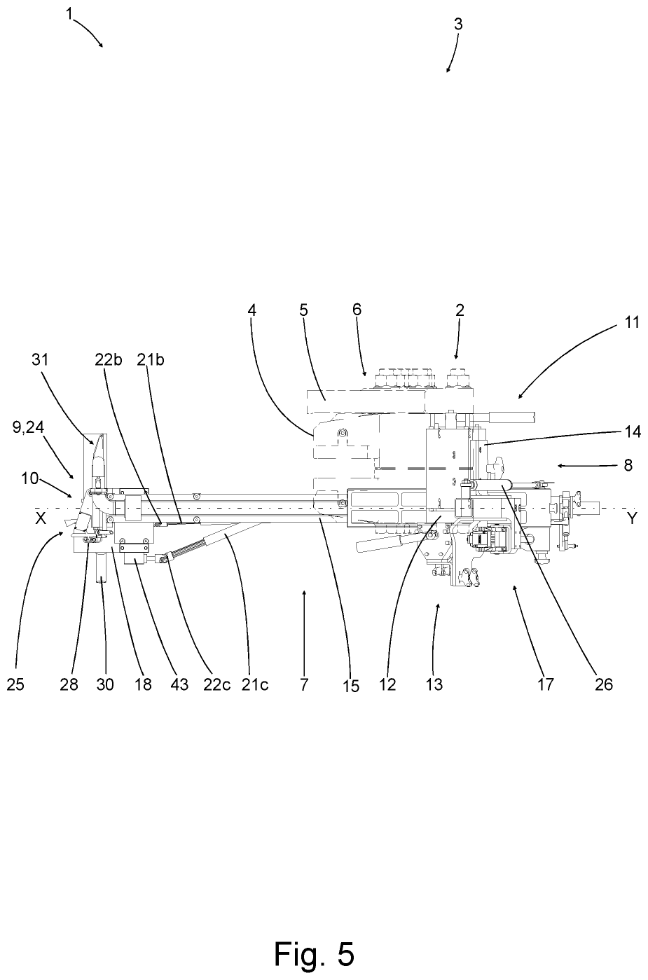

The repair device 1 has a control device 32 for controlling and/or regulating the repair device 1, expediently at least, however, the pivoting device 17, the alignment device 10 and the end effector 9. The control device 32 is preferably designed as a programmable logic controller (PLC). The control device 32 is shown by way of example in FIG. 2.

In one embodiment (not shown), the repair device 1 has a plurality of end effectors 9, 24 in order to carry out various method steps in a fully automated manner and without exchanging the end effectors 9, 24. The end effectors 9, 24 can be arranged on different support arms that can be addressed individually via the control device 32, wherein the support arms preferably correspond to the described support arm 15 in their embodiment.

The repair device 1 carries out the method for repairing corrosion damage of a surface of an object 2 exposed to weather. The method is used to repair corrosion damage of a surface of an object 2 formed by a wind turbine, in particular an offshore wind turbine, exposed to weather. Offshore wind turbines often experience corrosion damage due to the seawater weather conditions, meaning that the method can be optimally used in particular for repairing corrosion damage of a surface of an offshore wind turbine exposed to weather. The method is expediently carried out as an in-situ method—on site, namely at the wind turbine.

The method carried out by means of the repair device 1 has the method steps a) laserless pre-cleaning of the surface with the corrosion damage, b) laser cleaning of the surface with the corrosion damage and c) coating of the surface treated by laser cleaning with a protective layer. The protective layer can be designed as a coating and/or sealant.

The pre-cleaning of the surface with the corrosion damage expediently comprises the pre-cleaning steps of preliminary cleaning, desalination and drying of the surface. The individual precleaning steps of pre-cleaning are preferably done in the aforementioned order, i.e. preliminary cleaning, desalination and drying. It is possible to miss out individual pre-cleaning steps but this is not really recommended.

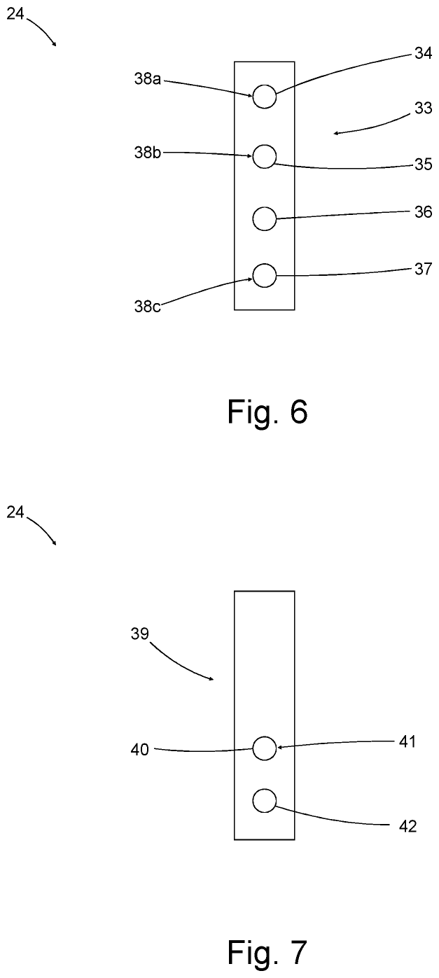

The repair device 1 has a further end effector 24 that can be used for preliminary cleaning and is designed as a pre-cleaning device 33. It has a preliminary cleaning unit 34, a desalination unit 35, a concentration measurement unit 36 and a drying unit 37 and is shown schematically in FIG. 6. For this purpose, the pre-cleaning device 33 has three nozzle systems 38a-c and the concentration measurement unit 36. In order to more easily differentiate the nozzle systems, they are marked a to c. The nozzle systems 38a-c can preferably be individually aligned and are respectively connected to a system source via a network associated with the respective nozzle system 38a-c. Thanks to its connection to the control device 32, the pre-cleaning device 33 is expediently fully automated or automatable.

Preliminary cleaning is preferably carried out with a cleaning agent, in particular a chemical cleaning agent, for example a water-soluble surfactant, which is sprayed onto the surface subject to preliminary cleaning by means of nozzle system 38a of the pre-cleaning device 33. Preliminary cleaning is used, for example, to clean oil-containing contaminants, contaminants resulting from wear parts, coarse salt contaminants and other contaminants caused by dirt or the like from the surface with the corrosion damage.

According to one embodiment (not illustrated), preliminary cleaning is carried out by means of mechanical cleaning, for example by means of a brush unit arranged on the end effector 9, 24, which preferably has one or more brush heads. The brush unit expediently has a metal brush, which is pressed against the surface to be cleaned and thus wipes off dirt particles and removes paint and corrosion particles. Compressed air is used to make them easier to remove. As with chemical cleaning, for example, oil-containing contaminants, contaminants resulting from wear parts, coarse salt contaminants and other contaminants caused by dirt or the like are cleaned from the surface with the corrosion damage.

Desalination is subsequently carried out preferably with deionized water, which is sprayed onto the surface that has been subject preliminary cleaning by means of corresponding nozzle system 38b of the pre-cleaning device 33. Deionized water is also referred to as demineralized or distilled water. In principle, any liquid that can absorb salt ions to desalinate the surface is suitable. Water is particularly suitable as it does not attack the surface to be pre-cleaned.

After desalination, a concentration measurement of the soluble salts is preferably carried out on the surface with the corrosion damage. The concentration measurement of the soluble salts is carried out by means of the Bresle method. When protecting surfaces exposed to weather, the surface must be checked for salt contamination prior to coating. Salt contamination may have a considerable impact on the adhesion and quality of the coating. The Bresle method based on increasing the electrical conductivity of water as a function of the concentration of salt ions is standard for this test according to ISO standards 8502-6 and 8502-9.

The surface is preferably dried with unoiled compressed air, which is also applied via the corresponding nozzle system 38c of the pre-cleaning device 33. This removes the residues of the preliminary cleaning and/or desalination from the surface with the corrosion damage and does not contaminate the surface.

The previously described pre-cleaning device 33 can also be designed as four individual end effectors 24.

After pre-cleaning, the surface with the corrosion damage is subjected at least partially to a material-removing surface post-treatment, if necessary. For example, edges formed by the surface are removed. This preparatory measure also ensures improved adhesion of the applied protective layer on the surface and thus provides a higher quality and more long-lasting coating. For this purpose, a further end effector 24 can be used and is arranged on the alignment device 10.

Laser cleaning of the surface with the corrosion damage is subsequently carried out. Lasers with specially configured class 4 solid-state lasers are used for this purpose. The corroded material is removed from the surface by vaporization or burning by means of a laser beam emitting short laser pulses that strike the surface to be cleaned in a concentrated manner. The laser cleaning thus enables selective, gentle, deep and damage-free cleaning of the surface with the corrosion damage. At the same time, the removed corroded material is extracted by means of an extraction device 31 arranged beneath the laser head 29 so that the surface to be cleaned with the laser device 25 substantially no longer has any residues of the corroded material after laser cleaning.

After the laser cleaning, an inspection of the surface roughness of the surface treated with the laser beam is preferably carried out, if necessary. In order to inspect the surface roughness, an impression of at least part of the laser-cleaned surface is produced from one or more technical silicones and the surface roughness of the impression is analysed. Only the part of the laser-cleaned surface used for the impression is cleaned again after producing the impression. Re-cleaning is preferably carried out. This is carried out with an alcohol, expediently with propan-2-ol. The surface roughness test enables the—usually downstream—assessment of the surface prepared for coating in an analysis laboratory and thus an assessment of the quality and durability of the applied protective layer. The surface roughness of the laser-cleaned surface should preferably be less than is or equal to 1 μm. For this purpose too, a further end effector 24 designed as an impression-taking device can be used and arranged on the alignment device 10.

The protective layer is then applied to the surface treated by the laser cleaning in one or more layers. It is applied in the illustrated embodiment by means of a further end effector 24 designed as a coating device 39. Such a coating device is schematically shown in FIG. 7 and is designed as a nozzle system 41 having a spray nozzle 40, a pipe system and a system source for storing the coating material. The spray nozzle 40 is designed as a single-component nozzle or multicomponent nozzle depending on the coating to be applied. By way of example, a multi-layered protective layer enables further improvement of the quality and durability of the applied coating compared to a single-layer protective layer. Various layers with different layer thicknesses can also be produced here in order to adapt the coating to the requirements of the weather. By way of example, spray or brush coating, a cartridge gun or manual application of the corrosion inhibitor can be used as a coating device.

Suitable coatings include, inter alia, SIKA SikaCor SW-1000 RepaCor, STEELPAINT or HEMPEL Hempadur EM 35740.

The coating device also provides the option of applying a surface sealant. Sealants such as STOPAQ Easy-Qote VE Paste or Easy-Qote VE Basecoat can be used, for example.

A layer thickness measurement device 42 is suitable for determining the layer thickness of the protective layer applied to the treated surface in a non-destructive method. Non-destructive methods include, inter alia, eddy current testing, microwave testing, ultrasound testing. The layer thickness measurement device 42 is preferably arranged on an end effector 24, particularly preferably together with the coating device 39 on an end effector 24. The layer thickness is expediently measured after drying the protective layer or at the same time as coating the surface.

1. A method for repairing corrosion damage of a surface of an object exposed to weather by means of a repair device having the method steps:
a) laserless pre-cleaning of the surface with the corrosion damage,
b) laser cleaning of the surface with the corrosion damage and
c) coating of the surface treated by laser cleaning with a protective layer.

2. The method according to claim 1, wherein pre-cleaning of the surface with the corrosion damage comprises preliminary cleaning and/or desalination and/or drying of the surface.

3. (canceled)

4. (canceled)

5. The method according to claim 2, wherein after desalination, a concentration measurement of the soluble salts is carried out on the surface with the corrosion damage.

6. The method according to claim 5, wherein the concentration measurement of the soluble salts is carried out by means of the Bresle method.

7. The method according to claim 2, wherein the surface is dried with unoiled compressed air.

8. The method according to claim 1, wherein after pre-cleaning of the surface with the corrosion damage, this surface is at least partially subjected to a material-removing surface posttreatment.

9. The method according to claim 8, wherein edges formed by the surface are removed.

10. The method according to claim 1, wherein the laser cleaning of the surface with the corrosion damage comprises removing the corroded material by a laser beam and extraction of the removed corroded material.

11. The method according to claim 1, wherein after the laser cleaning, an inspection of the surface roughness of the surface treated with a laser beam is carried out.

12. (canceled)

13. The method according to claim 11, wherein an impression of at least part of the laser-cleaned surface is produced and only the part of the laser-cleaned surface used for the impression is cleaned again after producing the impression.

14. (canceled)

15. The method according to claim 1, wherein the protective layer is applied to the surface treated by the laser cleaning in one or more layers.

16-18. (canceled)

19. A repair device for repairing corrosion damage of a surface of an object exposed to weather, having a support device having an alignment device suitable for receiving an end effector, wherein the alignment device is suitable for displacing and/or pivoting the end effector arranged on the alignment device, wherein the support device has a holding device, by means of which the support device can be attached to the object in such a way that the alignment device receiving the end effector is positioned in the area of the corrosion damage.

20. The repair device according to claim 19, wherein the end effector is releasably arranged on the alignment device to enable an exchange with another end effector.

21. The repair device according to claim 19, wherein the holding device has a fastening device for releasably attaching the support device to the object.

22. The repair device according to claim 19, wherein the fastening device is designed as a permanent magnetic device for magnetically attaching the support device to the object.

23. The repair device according to claim 19, wherein the holding device has a base body, on which the fastening device and a support arm supporting the alignment device arranged.

24. (canceled)

25. The repair device according to claim 19, wherein the alignment device has an end effector support moveably arranged on the support arm and positioning means, by means of which the end effector support can be moved and aligned relative to the support arm.

26. The repair device according to claim 19, wherein the end effector is designed as a laser device and/or as a pre-cleaning device and/or as a coating device and/or as a drying device and/or as an impression-taking device and/or as a layer thickness measurement device.

27. (canceled)

28. The repair device according to claim 26, wherein the laser device has an extraction device for extracting corroded material that occurs during the removal of the corrosion.

29. The repair according to claim 26, wherein the pre-cleaning device has a preliminary cleaning unit and/or a desalination unit and/or a drying unit and/or a concentration measurement unit.

30. (canceled)

31. A repair system having a repair device for repairing corrosion damage of a surface of an object exposed to weather, having a support device having an alignment device suitable for receiving an end effector, wherein the alignment device is suitable for displacing and/or pivoting the end effector arranged on the alignment device, wherein the support device has a holding device, by means of which the support device can be attached to the object in such a way that the alignment device receiving the end effector is positioned in the area of the corrosion damage and a wind turbine, wherein the repair device is releasably attached to the wind turbine.

32. The repair system according to claim 31, wherein the repair device is attached to a brake caliper of a rotor braking device of the wind turbine.

33. (canceled)
